(19) United States
(12) Patent Application Publication
(10) Pub. No.: US 2024/0413477 A1
(43) Pub. Date: Dec. 12, 2024

(54) Traction battery for a vehicle

(71) Applicant: Dr. Ing. h.c. F. Porsche Aktiengesellschaft, Stuttgart (DE)

(72) Inventors: Zeljko Glavaski, Benningen am Neckar (DE); Tomas Lanek, Prag 5 (CZ)

(73) Assignee: Dr. Ing. h.c. F. Porsche Aktiengesellschaft, Stuttgart (DE)

(21) Appl. No.: 18/655,375

(22) Filed: May 6, 2024

(30) Foreign Application Priority Data
Jun. 7, 2023 (DE) 10 2023 114 918.0

(51) Int. Cl. H01M 50/383; B60L 50/64; H01M 10/613; H01M 10/625; H01M 10/6568; H01M 50/213; H01M 50/682

(52) U.S. Cl. CPC H01M 50/383; B60L 50/64; H01M 10/613; H01M 10/625; H01M 10/6568; H01M 50/213; H01M 50/682; H01M 2220/20

(57) ABSTRACT

A traction battery for a vehicle includes a plurality of battery cells and a cooling unit. The cooling unit includes a fluid coolant and a cooling channel, wherein the coolant is disposed in the cooling channel and is configured to flow around the battery cells in the cooling channel and to absorb heat. The coolant is configured to be at least partially converted by a triggering event into an extinguishing foam.

### CROSS-REFERENCE TO RELATED APPLICATION

This application claims priority to German Patent Application No. 10 2023 114 918.0, filed Jun. 7, 2023, the content of such application being incorporated by reference herein in its entirety.

### FIELD OF THE INVENTION

The present invention relates to a traction battery for a vehicle.

### BACKGROUND OF THE INVENTION

From CN 206 535026 U, which is incorporated by reference herein, a battery cooling circuit is known which is connected to a container having an aerosol fire extinguishing agent that, if required, flows around the battery cells.

### SUMMARY OF THE INVENTION

Described herein is a traction battery with which the spreading of fire is particularly efficiently slowed or prevented in the event of a fire. In addition, a motor vehicle having such a traction battery is to be described.

The traction battery comprises a plurality of battery cells and a cooling unit. The cooling unit comprises a fluid coolant and a cooling channel. In the context of this description, a fluid coolant is understood to mean, in particular, a liquid. The coolant is disposed in the cooling channel and is configured to flow around the battery cells in the cooling channel and to absorb heat. Preferably, the coolant can be configured to flow through the entire cooling channel.

The coolant is also configured to be at least partially converted into an extinguishing foam by a triggering event. For example, the coolant can be a mixture of a plurality of components. It can comprise, for example, a cooling liquid having a particularly high specific heat capacity, in particular of greater than 2 kJ/(kg*K), preferably of greater than 3 Kj/(kg*K), and a foam generating means which is configured to convert the coolant at least partially into the extinguishing foam by way of the triggering event. It is possible, in particular, that the extinguishing foam contains air. Therein, the air can be incorporated into the extinguishing foam from the surrounding environment of the cooling channel, for example, if the cooling channel is already damaged by a fire. For the foam generating means, for example, substances used in the prior art for immersion cooling are suitable. This can in particular be a dielectric liquid.

Such a traction battery is advantageous since the coolant is particularly well suited for removing heat generated by the battery cells during operation and also, in the event of a fire, automatically and efficiently inhibits or prevents the spread of the fire.

The traction battery is configured for a vehicle. This can be, for example, a motor vehicle or also a rail vehicle, for example an ICE.

The coolant mentioned in this description can also be used in combination with lithium ion accumulators to slow or prevent the spreading of a fire.

According to one embodiment of the invention, the triggering event can be an exceeding of a threshold temperature of the coolant, an application of an electric voltage to the coolant, a contact of the coolant with oxygen, and/or an application of mechanical force to the coolant. For example, if the threshold temperature is exceeded, a chemical reaction can be triggered which at least partially converts the coolant into the extinguishing foam. For example, contact of the coolant with oxygen can occur if damage occurs to a housing of the traction battery.

According to one embodiment of the invention, the coolant can comprise a cooling liquid and a foam generating means. The foam generating means can be configured to trigger the at least partial conversion of the coolant into the extinguishing foam. For example, as a foam generating means, segregated hydrofluoroether, C₄F₉OC₂H₅, or methoxy-nonafluorobutane, C₄F₉OCH₃, can be used.

According to one embodiment of the invention, the cooling unit can comprise a valve configured, if a pressure threshold within the cooling channel is exceeded, to allow an escape of the extinguishing foam from the cooling channel by at least partially converting the coolant into the extinguishing foam. In this way, the spreading of the fire can be particularly efficiently hindered or even prevented.

According to one embodiment of the invention, the battery cells can be arranged in a plurality of groups. The battery cells of each of the groups can each be disposed around a center of the respective group. The cooling channel can have a plurality of protrusions, each projecting into the centers. For example, each of the groups can have exactly one single center around which the battery cells of that group are disposed. The battery cells can, in particular, be held in this arrangement by a holding means. The coolant can also flow, in particular, through the protrusions.

In this embodiment, the heat generated by the battery cells during operation is particularly efficiently dissipated.

According to one embodiment of the invention, the protrusions can abut the battery cells.

According to one embodiment of the invention, the cooling unit can comprise a first element and a second element. The first element and the second element can each comprise portions of the cooling channel. For example, the two elements can consist of an elastomer, a thermoplastic, or an elastic polymer. The first element can abut with a first abutment surface against a first side of the battery cells and comprise a first coolant inlet and a first coolant outlet. In the context of this description, a coolant inlet is understood to mean a region through which the coolant flows into the respective component during operation. A coolant outlet is understood in the context of this description to mean a region through which the coolant flows out of the respective component during operation. The coolant flowing through the coolant outlet has a higher temperature than the coolant flowing through the coolant inlet.

The second element can abut a second abutment surface on a second side of the battery cells. The second side can be arranged opposite to the first side. The second side can comprise a second coolant inlet and a second coolant outlet. The first element can comprise a first plurality of protrusions. The second element can comprise a second plurality of protrusions. The first plurality of protrusions extend into the centers from the first abutment surface. The second plurality of protrusions extend into the centers from the second abutment surface. It is possible, in particular, that the coolant is configured also to flow through the protrusions.

For example, it is possible that a protrusion of the first plurality and a protrusion of the second plurality can project into each of the centers, respectively.

It is also possible that the protrusions the first and the second plurality each extend together more than three quarters of the distance between the first and second sides of the battery cells.

It is further possible that the protrusions of the first plurality and the protrusions of the second plurality contact each other in the centers. The protrusions can each have the same length, wherein the protrusions extend into the centers with their length.

Preferably, the protrusions of the first plurality are fluidically separated from the protrusions of the second plurality. This can in particular mean that the coolant cannot flow directly from one of the protrusions of the first plurality into one of the protrusions of the second plurality.

With this embodiment, a particularly good removal of the heat generated by the battery cells during operation can be achieved. In addition, the traction battery can be produced particularly easily. It is further possible to adapt the traction battery to requirements since individual groups of battery cells can be added or removed. Only the first element and the second element then need to be adapted.

According to one embodiment of the invention, the protrusions can have a circular cylindrical shape.

According to one embodiment of the invention, the battery cells can have a circular cylindrical shape. In particular, the height of the circular cylinder can correspond, in particular, to the distance between the first and the second side of the battery cells.

It is also possible for the cooling channel to flow around the batteries only on one side. For example, the cooling channel can be disposed above or below a battery module having a plurality of battery cells. Further, it is possible that a plurality of cooling channels is provided, for example one arranged above and one below a single battery module with a plurality of battery cells. It is also possible for a cooling channel to be arranged between two battery modules.

For example, the cooling channel can be part of a cooling element, particularly if it is arranged exclusively above or below a battery module or between two battery modules, said cooling element having a modulus of elasticity of less than 5 Gpa at 20° C., preferably less than 2 Gpa at 20° C.

The motor vehicle comprises an electric drive system and a traction battery according to one embodiment of the invention. The traction battery is configured to supply electrical energy to the electric drive. In particular, the electric drive is herein understood to mean a motor that is configured to cause the entire motor vehicle to move.

### BRIEF DESCRIPTION OF THE DRAWINGS

Further features and advantages of the present invention are disclosed in the following description of a preferred exemplary embodiment, making reference to the appended drawings. Therein the same reference numerals are used for the same or similar components and for components having the same or similar functions. In the drawings:

FIG. 1 shows a schematic exploded view of a traction battery according to one embodiment of the invention;

FIG. 2 shows a schematic perspective view of a holding means according to one embodiment of the invention;

FIG. 3 shows a schematic cross-sectional view through the traction battery of FIG. 1;

FIG. 4 shows a schematic perspective representation of the traction battery of FIG. 1;

FIG. 5 shows a schematic cross-sectional view of the traction battery of FIG. 4 along the cross-sectional line A-A;

FIG. 6 shows a schematic cross-sectional view of a traction battery according to one embodiment of the invention with a cooling element disposed above a battery module;

FIG. 7 shows a schematic cross-sectional view of a traction battery according to one embodiment of the invention with a cooling element disposed below a battery module; and

FIG. 8 shows a schematic cross-sectional view of a traction battery according to one embodiment of the invention with a cooling element arranged between two battery modules.

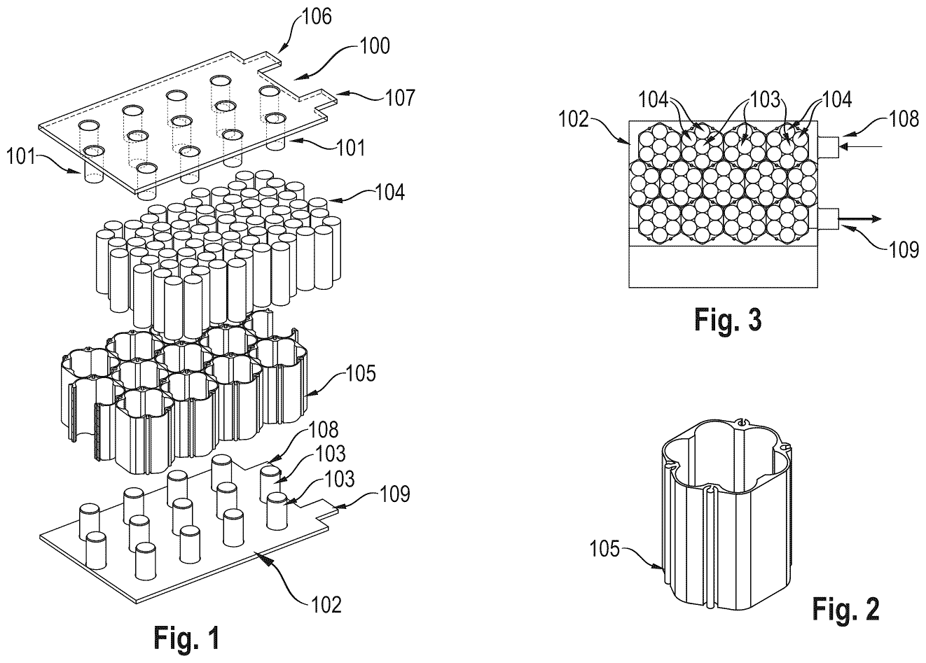

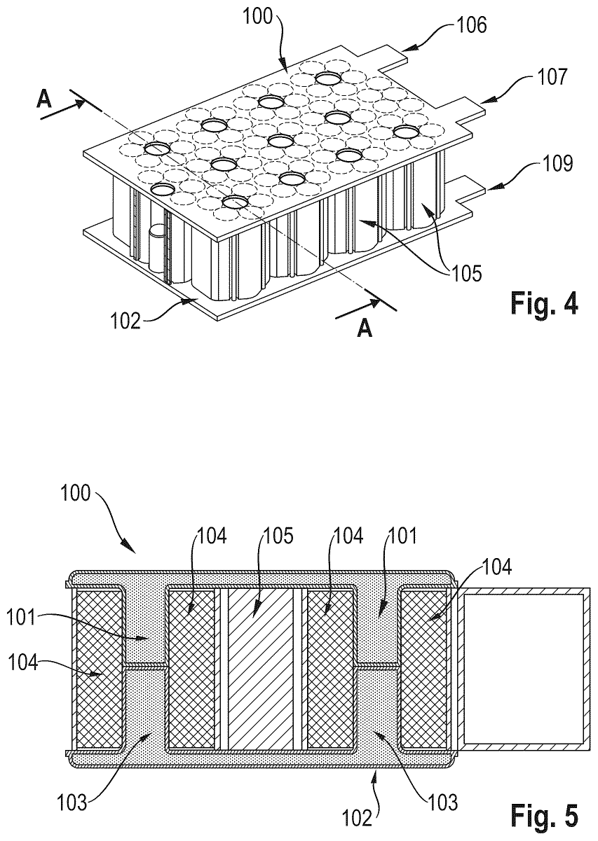

### DETAILED DESCRIPTION OF THE INVENTION

The traction battery comprises a first element 100 having a first plurality of protrusions 101, not all of which are provided with a reference numeral, for the sake of clarity. The first element 100 comprises regions of a cooling channel. The cooling channel also extends into the projections 101. For this purpose, during operation, the coolant flows into the first element 100 through the coolant inlet 106 of the first element 100, flows through the element including the protrusions 101, and flows out of the first element 100 again through the coolant outlet 107 of the first element 100.

The traction battery also comprises a second element 102 having a second plurality of protrusions 103, all of which are not provided with a reference numeral, for the sake of clarity. The second element 102 includes portions of the cooling channel. The cooling channel also extends into the protrusions 103. For this purpose, during operation, the coolant flows into the second element 102 through the coolant inlet 108 of the second element 102, through the element including the protrusions 103, and flows out of the second element 102 again through the coolant outlet 109 of the second element 102.

Both the protrusions 101 and the protrusions 103 have a circular cylindrical shape.

Between the first element 100 and the second element 102, battery cells 104 are disposed in holding means 105 (e.g., a sleeve, container or vessel). The battery cells 104 and the holding means 105, have again not all been provided with a reference numeral, for the sake of clarity. The battery cells 104 have a circular cylindrical shape and are in contact with the first element 100 and the second element 102 with their end surfaces.

The battery cells 104 are arranged in groups, with six battery cells 104 forming each group. Each group is arranged on a circular line about a center, with mutually adjacent battery cells 104 of a group touching one another.

The protrusions 101 of the first element 100 project from a first of the end surfaces of the battery cells 104 into the respective center. The protrusions 103 of the second element 102 project from a second of the end surfaces of the battery cells 104 into the respective center. In the middle between the two end surfaces, the protrusions 101 and 103 touch each other. This applies for all groups of battery cells 104 and the corresponding centers.

During operation, the battery cells 104 generate heat. The coolant flows through the coolant inlets 106 and 108 into the first element 100 and into the second element 102. The coolant also passes through the protrusions 101 and 103. Thus, the battery cells 104 are flowed around by coolant both at their end surfaces and also at the middle of the center about which they are disposed. Through the coolant outlets 107 and 109, the coolant flows back out of the first element 100 and the second element 102. The heat absorbed from the battery cells is thus dissipated from the first element 100 and the second element 102.

The coolant comprises a cooling liquid and a foam generating means. The foam generating means is configured to convert the coolant at least partially into an extinguishing foam. This conversion can be triggered by a triggering event. For example, the triggering event can be a heating to above a threshold temperature. Preferably, the threshold temperature is selected to be exceeded only in the event of a fire in one of the battery cells. In that eventuality, the converted coolant inhibits or prevents the spreading of the fire.

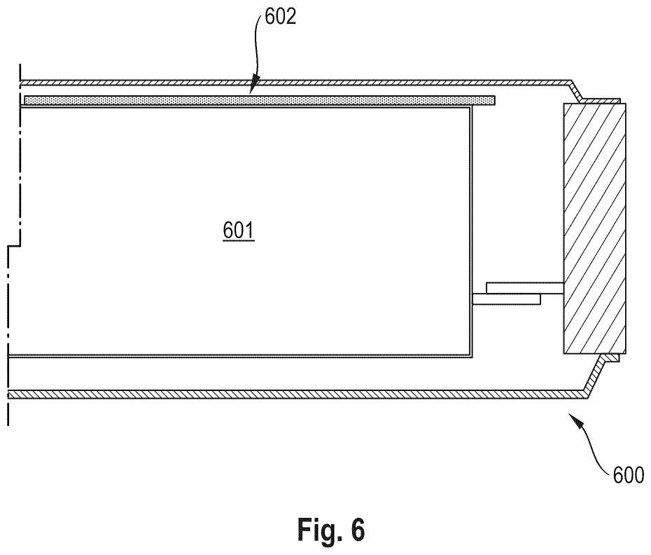

The traction battery 600 shown in FIG. 6 comprises a battery module 601 having a plurality of battery cells. A cooling element 602 having a cooling channel is disposed exclusively above the battery module 601.

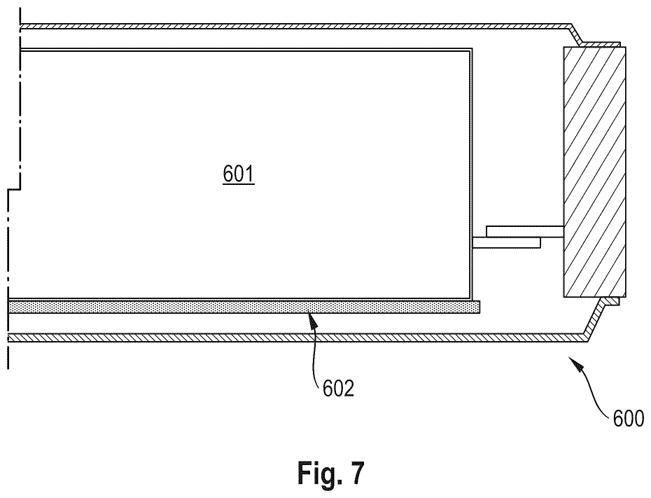

The traction battery 600 shown in FIG. 7 comprises a battery module 601 having a plurality of battery cells. A cooling element 602 having a cooling channel is disposed exclusively below the battery module 601.

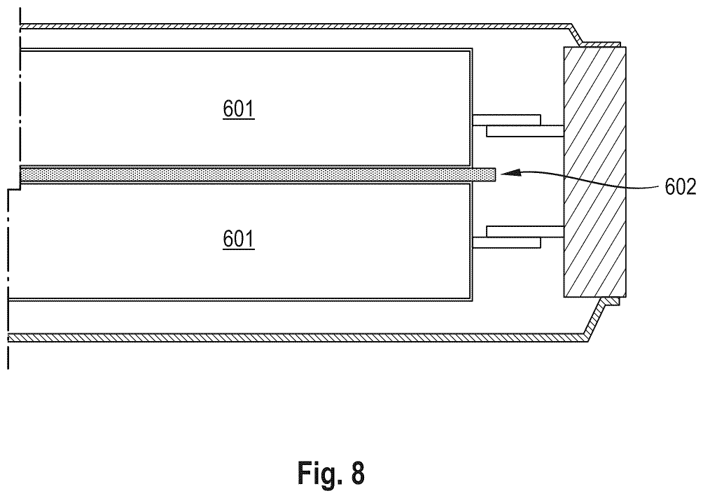

The traction battery 600 shown in FIG. 8 includes two battery modules 601 each having a plurality of battery cells. A cooling element 602 is disposed exclusively between the battery modules 601.

The coolant described above can flow in each of the cooling channels of the cooling elements 602.

The arrangements of the cooling elements 602 shown in FIGS. 6 to 8 can also be combined. For example, a cooling element 602 can be disposed above and a cooling element 602 can be disposed below a battery module. It is also possible for a cooling element 602 to be disposed below a lower battery module 601, a cooling element 602 to be disposed between two battery modules 601, and a cooling element 602 to be disposed above a battery module 601.

What is claimed is:

1. A traction battery for a vehicle, said traction battery comprising:
a plurality of battery cells; and
a cooling unit comprising a fluid coolant and a cooling channel,
wherein the coolant is disposed in the cooling channel and is configured to flow around the battery cells in the cooling channel and to absorb heat,
wherein the coolant is configured to be at least partially converted by a triggering event into an extinguishing foam.

2. The traction battery according to claim 1, wherein the triggering event is an exceeding of a threshold temperature of the coolant, an application of an electric voltage to the coolant, a contact of the coolant with oxygen, and/or an application of a mechanical force to the coolant.

3. The traction battery according to claim 1, wherein the coolant comprises a cooling liquid and a foam generator, the foam generator being configured to trigger the at least partial conversion of the coolant into the extinguishing foam.

4. The traction battery according to claim 1, wherein the foam generator is either segregated hydrofluoroether or methoxy-nonafluorobutane.

5. The traction battery according to claim 1, wherein the cooling unit comprises a valve that is configured to enable an emergence of the extinguishing foam from the cooling channel if a pressure threshold is exceeded within the cooling channel, by the at least partial conversion of the coolant into the extinguishing foam.

6. The traction battery according to claim 1, wherein the battery cells are arranged in multiple groups, wherein the battery cells of each of the groups are arranged around a center of the respective group, and wherein the cooling channel comprises a plurality of protrusions projecting into the centers of the respective groups.

7. The traction battery according to claim 6, wherein the protrusions abut the battery cells.

8. The traction battery according to claim 6, wherein the cooling unit comprises a first element and a second element, wherein the first element and the second element each comprise regions of the cooling channel, wherein the first element abuts a first side of the battery cells with a first abutment surface and comprises a first coolant inlet and a first coolant outlet, wherein the second element abuts a second abutment surface on a second side of the battery cells and comprises a second coolant inlet and a second coolant outlet, wherein the first element comprises a first plurality of protrusions, wherein the second element comprises a second plurality of protrusions, wherein each of the first plurality of protrusions extends into the center of one of the groups from the first abutment surface, and wherein each of the second plurality of protrusions extends into the center of one of the groups from the second abutment surface.

9. The traction battery according to claim 8, wherein the protrusions have a cylindrical shape.

10. The traction battery according to claim 1, wherein the battery cells have a cylindrical shape.

11. A motor vehicle comprising an electric drive system and the traction battery according to claim 1, wherein the traction battery is configured to supply electrical energy to the electric drive system.
